(19) United States
(12) Patent Application Publication
(10) Pub. No.: US 2008/0201506 A1
(43) Pub. Date: Aug. 21, 2008

(54) Switch device for connection port access control

(75) Inventor: Chun-Liang Lee, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/708,278

(22) Filed: Feb. 19, 2007

(51) Int. Cl. G06F 13/00

(52) U.S. Cl. 710/100

(57) ABSTRACT

A switch device for connection port access control is applicable to a PS/2 connection port for converting a USB transmission specification to a PS/2 transmission specification. The switch device includes a universal serial bus (USB) expansion unit, which provides a plurality sets of USB transmission line, each set of USB transmission line having a USB connection port signal line and a first power supply control line; a USB-PS/2 conversion unit for converting the USB connection port signal line of a set of USB transmission line to a PS/2 connection port signal line; a logic unit having a first input end, a second input end, and an output end, the logic unit processing signals received by the first and second input ends and outputting the processed signal through the output end to form the output end into a second power supply control line; and a PS/2 connection port.

### BACKGROUND OF THE INVENTION

1. Field of the Invention

This invention relates generally to a switch device for connection port access control, and more specifically, to a switch device, which is applicable to connect a PS/2 connection port that is capable of converting an USB transmission specification to a PS/2 transmission specification, and when there is a peripheral device access control switch between two server ends of a blade server, the PS/2 connection port is capable of building a connection with the server end that sends out the access control switch request.

2. Description of Related Art

Since a server has higher computing power and strong memory capacity, and meanwhile it allows multiple user to access, with the prosperity of network nowadays, the server has a great deal of importance in the network architecture. Furthermore, to response to the network high efficiency process, a blade server architecture has been developed under the server architecture, the blade server has multiple pieces of server units in a chassis, each server unit can operate independently, therefore, blade server dramatically enhances the power of the original server.

Since a blade server can provide operations of multiple server units, when testing on an individual server unit or processing data input/output on a specific server unit, the job is commonly done through an universal serial bus (USB) HUB that provides a plurality of USB connection ports for the system manager to use the peripheral devices, such as monitor, keyboard, and mouse, etc. to control the plurality of server units of the blade server, and for the reason that these peripheral devices may support an input/output interface of a specific specification, in addition to the general USB connection ports provided by the USB HUB, a USB-PS/2 conversion unit converts the signal transmitted by the USB connection port to a signal that can be transmitted by a second generation personal system (PS/2) connection port, and then provides a means of communication between the blade server and the peripheral devices that connects to the PS/2 connection port.

Please refer to FIG. 1, which is a functional block diagram of a blade server 1 and a universal series bus (USB) hub 2 according to the prior art. The blade server 1 comprise a first server unit 10, a second server unit 11, an intelligent platform management bus (IPMB) 120, and a chassis management controller (CMC) 12 controlling the first server unit 10 and second server unit 11 via the IPMB 120. Note that a number of the server units in FIG. 1 is not restricted two as shown herein, in order to simplify the description and the diagram, the following description will use only the first server unit 10 and the second server unit 11 as examples, and since the blade server is a commonly known server system, the following description will not include further details of the blade server functions and its internal architecture. When a system manager wants to switch the access control of a peripheral device from the first server unit 10 to the second server unit 11, the CMC 12 outputs a power supply control signal to a USB expansion unit 20 of the USB hub 2, and the USB expansion unit 20 then outputs a plurality of activation signals to a plurality of first power supply control lines (200, 202, 204) and a second power supply control line 206 to switch on or off a plurality of USB connection ports (201, 203, 205) and a PS/2 connection port 207, to control a plurality of USB connection port signal lines (201a, 203a, 205a) and a PS/2 connection port signal line 207a′ to connect peripheral devices connected to the USB connection port signal lines (201a, 203a, 205a) and the PS/2 connection port signal line 207a′ with a server unit which issues a switch request. However, when the blade server 1 switches the peripheral device access control from the first server unit 10 to the second server unit 11, the PS/2 connection port signal line 207a′ and the second power supply control line 206 that controls the power supply on or off process of the PS/2 connection port 207 are respectively controlled by a USB-PS/2 conversion unit 21 and the USB expansion unit 20, consequently, the second server unit 11 that requests the peripheral device access control switch cannot judge the actions between the PS/2 connection port signal line 207a′ and the second power supply control line 206, in other words, because it cannot immediately inform the operation system of the second server unit 11 of the peripheral device control access switch, relatively, it can not immediately shut off the power supply of PS/2 connection port 207, therefore, in the process of access control switch, the PS/2 connection port 207 can not perform normally, namely, the peripheral device that connects to the PS/2 connection port 207 can not build a connection with the second server unit 11, thus affect the testing jobs and the controlling operations performed by the system manager.

Hence, it is a highly urgent issue in the industry for how to provide a technique which can effectively prevent any PS/2 connection port data transmission failure while converting from USB transmission specification to PS/2 transmission specification for a peripheral device access control switch between two server units of the blade server.

### SUMMARY OF THE INVENTION

In views of the disadvantages of the prior art mentioned above, it is a primary objective of the present invention to provide a connection port access control switch device, which is applicable to a PS/2 connection port for converting an USB transmission specification to a PS/2 transmission specification, and can effectively solve the problem that when a peripheral device access control switch between two server units of the blade server can not build a connection between the PS/2 connection port and the server unit that requests for the access control switch.

To achieve the above-mentioned and other objectives, a connection port access control switch device is provided according to the present invention, which is applicable to a blade server, the blade server has a plurality of server units and at least a chassis management controller, the chassis management controller outputs a power supply control signal on account of a peripheral device access control switch request sent out by a server unit, and then the connection port access control switch device builds a connection between the peripheral device and the server unit that sent out the access control switch request based on the power supply control signal output by the chassis management controller, the connection port access control switch device comprises: an universal serial bus (USB) expansion unit, which is for providing a plural sets of USB transmission line, each set of USB transmission line has a USB connection port signal line and a first power supply control line, and then to form a plurality of connection USB connection ports, each individual USB connection port can selectively connect to a first peripheral device, the first power supply control line of each USB connection port shuts off the power supply of the USB connection port based on the power supply control signal output by the chassis management controller, thereby, after the USB connection port receives the power supply control signal, the chassis management controller switches the access control of the first peripheral device that is connecting to the USB connection port to the server unit that sends out the access control switch request, and the USB connection port signal line provides the server unit and the first peripheral device with a means of data transmission process; an USB-PS/2 conversion unit, which converts the USB connection port signal line of a set of USB transmission line provided by the USB expansion unit to a PS/2 connection port signal line that matches the PS/2 transmission specification; a logic unit, which has a first input end, a second input end, and an output end, wherein, the first input end of the logic unit electrically connects with the first power supply control line of the set of USB transmission line that is provided by the USB expansion unit for the USB-PS/2 conversion unit to execute the transmission specification conversion, and the power supply control signal that is output by the chassis management controller is transmitted to the second input end of the logic unit, the logic unit processes the signals received by the first input end and the second input end, and then outputs the processed signals through the output end to form the output end into a second power supply control line; and a PS/2 connection port, which can selectively connect to a second peripheral device, the PS/2 connection port consists of the PS/2 connection port signal line derived from the conversion process executed by the USB-PS/2 conversion unit and the second power supply control line formed after the process of signals by the logic unit, when a server unit sends out an access control switch request, the second power supply control line executes the processes of the power supply off and on of the PS/2 connection port, and then the PS/2 connection port builds a connection with the server unit that sends out the access control switch request, and also provides the server unit with the control over the second peripheral device that electrically connects to the PS/2 connection port.

In view of the above, the connection port access control switch device according to the present invention is capable of avoiding the problem that, according to the PS/2 connection port of the prior art, the server unit that sends out the peripheral device access control switch request can not judge the operations between the PS/2 connection port signal line and the power supply control line, and then the PS/2 connection port of the prior art can not immediately inform the server unit operation system of the peripheral device access control switch, consequently, in the process of access control switch, the PS/2 connection port of prior art can not operate normally.

### BRIEF DESCRIPTION OF DRAWINGS

The prior art and the present invention can be more fully understood by reading the following detailed description of the preferred embodiments, with reference made to the accompanying drawings, wherein:

FIG. 1 is a functional block diagram of a blade server and a universal series bus (USB) hub according to the prior art; and

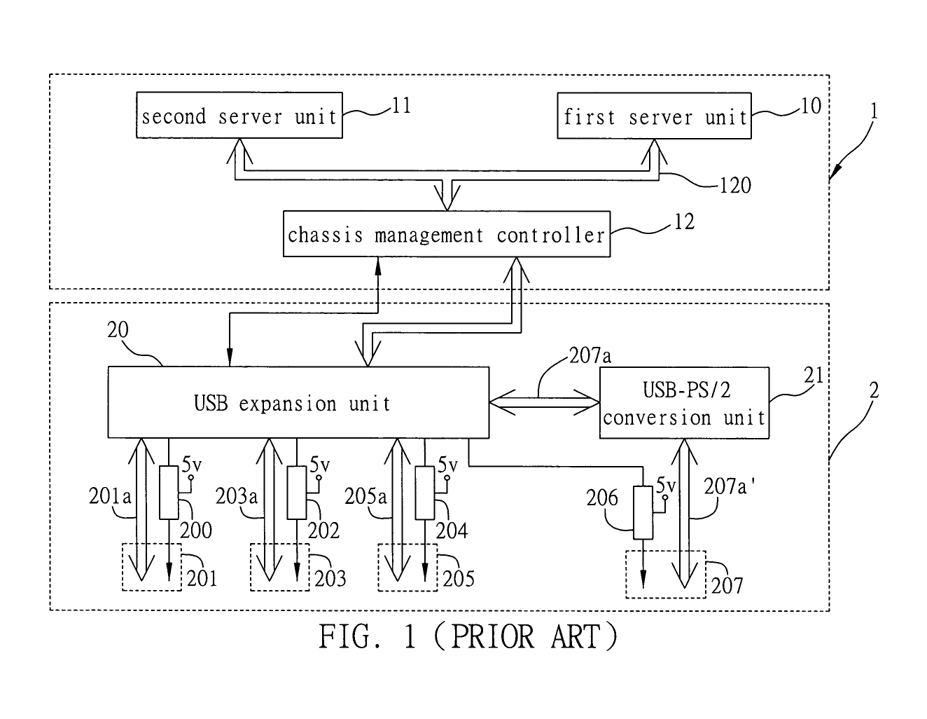

FIG. 2 is a functional block diagram of a blade server and a switch device of the preferred embodiment according to the present invention.

### DETAILED DESCRIPTION OF PREFERRED EMBODIMENTS

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

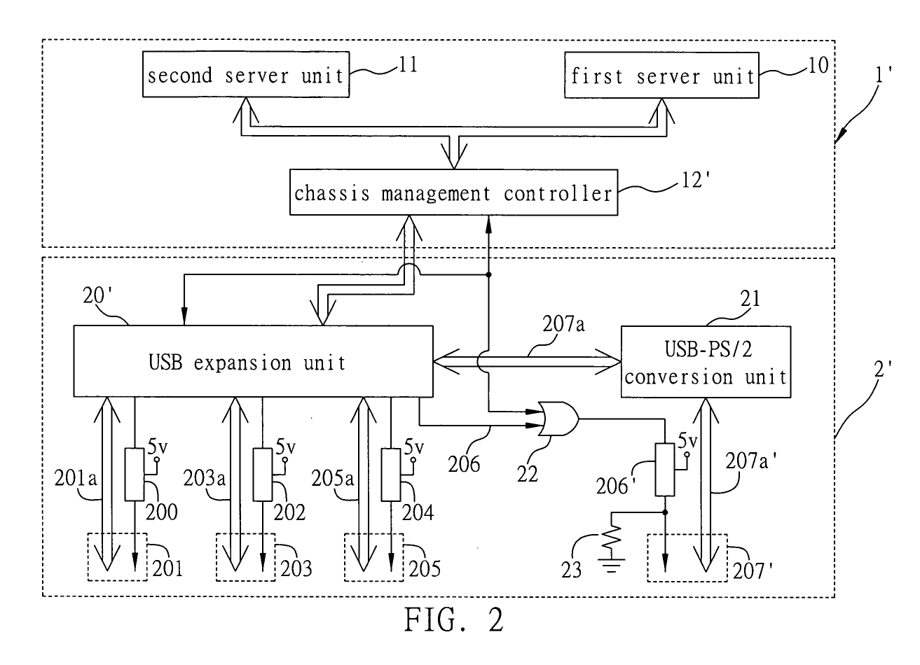

Please refer to FIG. 2, which is a functional block diagram of a blade server 1′ and a switch device 2′ of the preferred embodiment according to the present invention. The switch device 2′ is applicable to the blade server 1′. The blade server 1′ comprises a plurality of server units, the connection port access control switch device has a plurality of connection ports for connecting to a set of peripheral devices, and then provides the plurality of server units of the blade server 1′ with the capability of sharing the same set of peripheral devices with one another via the switch device 2′. Following is the description of the operation of the connection port access control switch device according to the present invention.

In the present embodiment, the blade server 1′ has at least a first server unit 10, a second server unit 11, and a chassis management controller 12′, the chassis management controller 12′ is for monitoring the operations of the first server unit 10 and the second server unit 11, for example, when it monitors that the temperature of the first server unit 10 or the second server unit 11 is too high, it activates a fan (not shown in the figure) to spin faster in order to lower down the temperature. It must be noted herein, in order to simply the description and figure, the description herein includes only the first server unit 10 and the second server unit 11, and the number of server units is not restricted to the number herein, the number of the chassis management controllers 12′ is not limited to the number in the present embodiment either, it can add another chassis management controller (not shown in the figure herein) as a backup, when one of the chassis management controllers has a breakdown, the backup chassis management controller will take charge of the jobs. Since the blade server is commonly known, the following description will not include the details of functions or the internal architecture of the blade server.

The connection port access control switch device 2′ according to the present invention comprises a universal serial bus (USB) expansion unit 20′, an USB-PS/2 conversion unit 21, a logic unit 22 and a PS/2 connection port 207′.

The USB expansion unit 20′ provides a plural sets of USB transmission lines (201a and 200, 203a and 202, 205a and 204), each set of USB transmission line having a USB connection port signal line (201 a, 203a, 205a) and a first power supply control line (200, 202, 204), thereby forming a plurality of USB connection ports (201, 203, 205). The USB connection port signal line (201a, 203a, 205a) is D+ and D− in a USB signal and adopts a twisted pair of data cables to transmit data, while the power supply control line (200, 202, 204) is power and ground pinouts provided by a USB connection port. It should be noted that the USB connection port structure is a prior art, further description hereby omitted. Each connection port (201, 203, 205) can selectively connect to a peripheral device (not shown in the figure herein), the first power supply control line (200, 202, 204) receives the power supply control signal output by the chassis management controller 12′, after receiving the power supply control signal, switches the access control of the peripheral device that is connecting to the connection port to the first server unit 10 or the second server unit 11 that sends out the peripheral device switch request, wherein, it is based on the peripheral device switch request sent out by the first server unit 10 or the second server unit 11, the chassis management controller 12′ outputs the power supply control signal to the USB expansion unit 20′, and then the power supply control signal shuts off the power supply of the first power supply control line (200, 202, 204) of each USB connection port (201, 203, 205), and continuously, it turns on the power supply of the first power supply control line (200, 202, 204), by doing this, each USB connection port (201, 203, 205) switches the access control of the peripheral device that is connecting to the USB connection port to the first server unit 10 or the second server unit 11 that sends out the switch request, wherein, the data transmission process between each peripheral device and the first server unit 10 or the second server unit 11 that sends out the switch request is via the USB connection port signal line (201a, 203a, 205a) of the USB connection port that connects to the peripheral device, the peripheral device is a, for example, monitor, keyboard, or mouse, etc.

The USB-PS/2 conversion unit 21 converts the USB connection port signal line 207a of a set of USB transmission line (206 and 207a) provided by the USB expansion unit 20′ to a PS/2 connection port signal line 207a′ that matches the PS/2 transmission specification. Since the USB-PS/2 conversion unit 21 is an essential member for the data transmission process between two devices having connection ports of different transmission specifications, and it belongs to a prior art, the details of its functions and architecture principle will not included in the following description.

The logic unit 22 has a first input end, a second input end, and an output end, wherein, the first input end of the logic unit 22 electrically connects to the first power supply control line 206 of the previous mentioned set of USB transmission line (206 and 207a) provided by the USB expansion unit 20′ for the USB-PS/2 conversion unit 21 to process the transmission specification conversion, and the second input end of the logic unit 22 electrically connects to the line where the chassis management controller 12′ outputs the power supply control signal, the logic unit 22 processes the signals received by the first input end and the second input end, and then outputs the processed signal through the output end, the signal output through the output end is a power supply control signal, thereby forming the output end into a second power supply control line 206′. The PS/2 connection port 207′ can selectively connect to a peripheral device, wherein, the PS/2 connection port 207's consists of the PS/2 connection port signal line 207a′ that is derived from the transmission specification conversion executed by the USB-PS/2 conversion unit 21 and the second power supply control line 206′ that is formed after the signal process by the logic unit 22, it must be noted herein, the second power supply control line 206′ has a common similarity of the construction elements and the principle with the first power supply control lines (200, 202, and 204) of the USB connection ports (201, 203, and 205) of the prior art, the only difference is that the second power supply control line 206′ controls the power supply on or off process of the PS/2 connection port 207′ based on the signal output by the output end of the logic unit 22, while the first power supply control lines (200, 202, and 204) of the USB connection ports (201, 203, and 205) of the prior art control the power supply on or off process of the corresponding USB connection ports (201, 203, and 205) based on the switch signal output by the USB expansion unit 20′.

When the first server unit 10 or the second server unit 11 sends out a peripheral device access control switch request, the chassis management controller 12′ outputs a power supply control signal based on the request, and then sends the signal to the USB expansion unit 20′ and the logic unit 22, by doing this, the second power supply control line 206′ executes the power supply off and on processes of the PS/2 connection port 207′, therefore, the PS/2 connection port 207′ builds a connection with the first server unit 10 or the second server unit 11 that sends out the access control switch request, and then provides the first server unit 10 or the second server unit 11 with the control over the peripheral device that electrically connects to the PS/2 connection port 207′.

In the present embodiment, the logic unit 22 is an OR gate, the power supply control line 206 of a set of USB transmission line provided by the USB expansion unit 20′ and the transmission line that is for the chassis management controller 12′ to output the power supply control signal separately connects to the input ends of the OR gate, and form the output end of the OR gate into the second power supply control line 206′, and then the OR gate controls the power supply on and off processes of the PS/2 connection port 207′ based on the signals received by its input ends.

In the present embodiment, the logic level of the power supply control signal sent by the chassis management controller 12′ to shut off the power supply of each of the connection ports (201, 203, 205, and 207′) is 1, after the power supply control signal being output and through the OR gate, the logic level is still 1, therefore, the second power supply control line shuts off the power supply of the PS/2 connection port 207′ on account of the received logic level 1; on the other side, the power supply control signal output by the chassis management controller 12′ also sends to the USB expansion unit 20′, the USB expansion unit 20′ shuts off and then turns on the power supply of each of the USB connection ports (201, 203, and 205) on account of the received logic level 1, by doing this, each of the USB connection port (201, 203, and 205) switches the access control of the peripheral device that is connecting to the USB connection port to the first server unit 10 or the second server unit 11 that sends out the switch request, as to the power supply control line 206 of the set of USB transmission line (207a and 206) that is provided by the USB expansion unit 20′ to function as the PS/2 connection port 207′, it also externally transmits the logic level 1 received by the USB expansion unit 20′ to the OR gate, and then the OR gate controls the power supply on and off processes of the PS/2 connection port 207′ on account of the power supply control line 206 of the USB expansion unit 20′, and then the PS/2 connection port 207′ switches the access control of the peripheral device that is connecting to the PS/2 connection port 207′ to the first server unit 10 or the second server unit that sends out the switch request.

It is obviously to know from the description mentioned above, the PS/2 connection port 207′ receives the power supply control signal output by the chassis management controller 12′ through the OR gate, and controls the power supply on and off processes of the PS/2 connection port 207′ on account of the logic level 1 transmitted by the power supply control line 206 of the USB expansion unit 20′, since the power supply control signal output by the chassis management controller 12′ will shut off the power supply of the PS/2 connection port, before the USB expansion unit 20′ executes the peripheral device access control switch process, the chassis management controller 12′ has already transmitted the power supply control signal to the PS/2 connection port 207′ and then shuts off the power supply of the PS/2 connection port 207′, after that, the USB expansion unit 20′, on account of the power supply control signal output by the chassis management controller 12′, executes the peripheral device access control switch process of the USB transmission line provided by the near-end. More specifically, the PS/2 connection port 207′ shuts off the power supply first on account of the power supply control signal output by the chassis management controller 12′, and after about 500 ms (millisecond) later, the USB expansion unit 20′ turns on the power supply by executing the access control switch process, therefore, it can effectively solve the problem caused by the PS/2 connection port provided by USB HUB of prior art, because in the prior art, the interfaces of the PS/2 connection port and the USB connection port are different, the PS/2 connection port can not, on account of the switch process of the USB HUB, turn on and shut off the power supply smoothly, therefore, the first server unit or the second server unit that sends out the switch request can not make a connection with the PS/2 connection port.

It must be noted herein, the time length of the previously mentioned 500 ms can be adjusted by the path length of the power supply control signal output by the chassis management controller 12′ from the USB expansion unit 20′ to the second power supply control line 206′.

It also must be noted herein, the logic unit 22 of the present invention is not restricted to the OR gate of the present embodiment, it is on account of the logic level of the power supply control signal for shutting off the power supply of each of the connection ports (201, 203, 205 and 207′), for example, if the logic level of the power supply control signal for shutting off the power supply of each of the connection ports (201, 203, 205, and 207′) is 0, the logic unit 22 can be an AND gate, namely, it all depends on the state of the embodiment.

By means of the logic unit 22 of the connection port access control switch device according to the present invention, the PS/2 connection port 207′ can shut off for at least 500 ms before it turns on again on account of the power supply control signal transmitted from the chassis management controller 12′, therefore, the operation system of first server unit 10 or the second server unit 11 that sends out the peripheral device access control switch request can recognize the peripheral device that has its power supply off and then on, for that reason, it can effectively avoid the problem that the PS/2 connection port of the prior art can not operate normally in the access control switch process, because in the prior art, the server unit that sends out the peripheral device access control switch request can not judge the operation between the PS/2 connection port signal line and the second power supply control line, and thus the operation system of the second server unit 11 can not be immediately informed of the peripheral device access control switch.

Furthermore, the second power supply control line 206′ derived from the output end of the logic unit 22 is connecting to one end of a resistor 23, and the other end of the resistor 23 is connecting to a grounding end, when the first server unit 10 or the second server unit 11 sends out the peripheral device access control switch request, by means of the resistor 23, the second power supply control line 206′ quickly executes the power supply off process of the PS/2 connection port 207′, namely, a quick discharge process. It must be noted herein, since the peripheral device that connects to the PS/2 connection port 207′, such as a keyboard or a mouse, consumes less power, after that the chassis management controller 12′, on account of the received peripheral device access control switch request, transmits the power supply control signals to the USB expansion unit 20′ and the logic unit 22, the second power supply control line 206′ executes the power off process of the PS/2 connection port 207′, but the peripheral device can not consume up the remaining power supply, in order to execute the power supply off process completely, the second power supply control line leads the remaining power supply to the grounding end via the serially connected resistor 23, thereby accomplishing the purpose of quick discharge.

In summary, the connection port access control switch device according to the present invention can effectively solve the problem that the PS/2 connection port of the prior art, which supports the PS/2 transmission specification, can not build a connection with the server unit that sends out the access control switch request when there is an access control switch between two server ends of the blade server, therefore, the connection port access control switch device according to the present invention enhances the stability of the blade server's access control switch process of the peripheral device that electrically connects to the PS/2 connection port the blade server.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A switch device for connection port access control, which is applicable to a blade server having a plurality of server units and at least a chassis management controller, the chassis management controller outputting a power supply control signal on account of an access control switch request of a peripheral device sent out by a server unit, and then based on the power supply control signal output by the chassis management controller, the switch device connecting the peripheral device with the server unit that issues the access control switch request, the switch device comprising
a universal serial bus (USB) expansion unit, which provides a plurality sets of USB transmission lines, each set of the USB transmission lines having a USB connection port signal line and a first power supply control line, to form a plurality of USB connection ports, each of the USB connection ports being selectively connectable with a first peripheral device;
a USB-PS/2 conversion unit, which converts the USB connection port signal line of one set of the USB transmission lines provided by the universal serial bus expansion unit to a PS/2 connection port signal line that complies with PS/2 transmission specification;
a logic unit, which has a first input end, a second input end, and an output end, the first input end electrically connecting the first power supply control line of the set of USB transmission line that is provided by the universal serial bus expansion unit for the USB-PS/2 conversion unit to execute a transmission specification conversion, the chassis management controller transmitting the output power supply control signal to the second input end of the logic unit, the logic unit processing signals received by the first input end and the second input end and then outputting the processed signals via the output end to form the output end into a second power supply control line; and
a PS/2 connection port, which is selectively connectable to a second peripheral device, the PS/2 connection port comprising the PS/2 connection port signal line derived from the transmission specification conversion executed by the USB-PS/2 conversion unit and the second power supply control line derived from the output end of the logic unit after the signal process; when a server unit issues an access control switch request, the second power supply control line executes the power supply off/on process of the PS/2 connection port, and the PS/2 connection port builds a connection with the server unit that issues the access control switch request and provides the server unit with the control over the second peripheral device that is electrically connecting to the PS/2 connection port.

2. The switch device of claim 1, wherein, the logic unit is an OR gate, and the power supply control signal output by the chassis management controller has a logic high level.

3. The switch device of claim 1, wherein the logic unit is an AND gate, and the power supply control signal output by the chassis management controller has a logic low level.

4. The switch device of claim 1, wherein the second power supply control line, which is derived from the output end of the logic unit, is connected to one end of a resistor, and the other end of the resistor is grounded; when a server unit issues an access control switch request, the second power supply control line executes a quick power supply off process of the PS/2 connection port by means of the resistor.

5. The switch device of claim 4, wherein the quick power supply off process of the PS/2 connection port means to shorten the PS/2 connection port discharge time.

6. The switch device of claim 1, wherein the first power supply control line of each of the USB connection ports provided by the universal serial bus expansion unit shuts off the power supply of the USB connection port on account of the power supply control signal output by the chassis management controller, and then, after the first power supply control line receives the power supply control signal, the chassis management controller switches the access control of the first peripheral device that is connecting to the USB connection port to the server unit that issues the access control switch request, and provides the server unit and the first peripheral device with a means of data transmission via the USB connection port signal line.
